(19) United States
(12) Patent Application Publication
(10) Pub. No.: US 2009/0291792 A1
(43) Pub. Date: Nov. 26, 2009

(54) TOOTHED BELT GEAR AND A PROCESS FOR PRODUCING THE SAME

(76) Inventor: STEPHAN OBERLE, Villingen-Schweningen (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 12/428,158

(22) Filed: Apr. 22, 2009

(30) Foreign Application Priority Data
May 26, 2008 (DE) 10 2008 025 077.5

(51) Int. Cl. F16H 55/17; B21D 13/00

(52) U.S. Cl. 474/153; 72/379.6

(57) ABSTRACT

A toothed belt gear for a toothed belt drive with a cup shaped or bell-shaped base body of metal and a cogging arranged on the outside circumference of the base body, in which the cogging of the base body is closed on each of both front sides by a flanged wheel and at least one of the flanged wheels is constructed as a separate part.

### CROSS REFERENCE TO RELATED APPLICATIONS

This application claims priority from German Patent Application No. 10 2008 025 077.5, filed May 26, 2008, the entire contents of which are herein incorporated fully by reference.

### FIGURE FOR PUBLICATION

FIG. 3.

### BACKGROUND OF THE INVENTION

1. Field of the Invention

The present invention relates to a toothed belt gear for a toothed belt drive. More specifically, the present invention relates to a toothed belt gear for a toothed belt drive, and wherein the toothed belt gear comprises a cup-shaped, or bell-shaped, base body of metal, for use in a motor vehicle drive train.

2. Description of the Related Art

The related art involves making a toothed belt gear for a toothed belt drive available that can be economically manufactured in as few process steps as possible and is capable of reliably guiding a toothed belt

The following German publications are exemplary of the related art:

DE 10 2005 061 481 A1 discloses a device, for use in a manual transmission, having a sliding sleeve adjustable from a neutral position toward a wheel. The device has teeth that engage a toothed belt drive. The tooth profiles move partly positively in relation to their counterpart notches; and, at the same time the tips of each tooth are separated by a distance from the notches.

DE 10 2006 059 946 A1 discloses a toothed belt wheel having a hub base body with a drum shaped section and toothing made up of phenolic-resin-based thermoplastic. The plastic portion lies at the outer circumference of the drum shaped section. The device is used as the tooth belt drive of a motor vehicle; and, has an advantage in its reduction of the operating loads at the motor vehicle steering assembly.

DE 103 52 256 A1 discloses a form locking connection achieved through a rolling body threaded drive having a spindle nut rotatably mounted on a threaded needle and a drive part attached in a rotationally fixed manner to the spindle nut. The drive part is made of a sprayable material that is sprayed onto the spindle nut to form a form-locking connection between the drive part and the spindle nut.

DE 102 37 557 A1 discloses a swashplate pump that is capable of reducing the RPM of a drive motor. The pump is useful for high pressure cleaning appliances and has pump pistons bearing upon a swashplate and a drive to set the swashplate in rotation. The drive further comprises a pinion which meshes with a gear ring installed on the swashplate concentrically to the rotational axis.

DE 10 2004 038 681 A1 discloses a camshaft adjuster having a triple shaft drive mechanism composed of: the drive wheel fixed to the crankshaft in the form of a sprocket or synchronous belt wheel with the outer part fixed to a camshaft; an adjusting shaft connected to the rotor of an electric motor; and, a stator fastened to the corresponding internal combustion engine. The advantage to this apparatus is the lower cost of production.

DE 10 2005 006 673 A1 discloses an process for the production of metal components to be provided with a plastic component on its out periphery by pressing a spherical indentation into a plate, incorporating a hole in the indentation, penetrating to form a receiver, bending downwards to form a collar, and forming axial grooves on the outer edge of the collar.

Thus, the related art discloses several production methods. However, what is clearly not appreciated by the related art is the unique combination of lower cost and optimal efficiency of an apparatus for guiding a toothed belt resulting in the combination for manufacturing efficiency.

Accordingly, there is a need for an improved toothed belt gear for a toothed belt drive available that can be economically manufactured in as few process steps as possible and is capable of reliably guiding a toothed belt.

### ASPECTS AND SUMMARY OF THE INVENTION

An aspect of the present invention is to provide a toothed belt gear for a toothed belt drive, and wherein the toothed belt gear comprises a cup-shaped, or bell-shaped, base body of metal.

Another aspect of the present invention is to provide a process for the manufacture of toothed belt gears in accordance with the invention.

The present invention relates to a toothed belt gear for a toothed belt drive with a cup shaped or bell-shaped base body of metal and a cogging arranged on the outside circumference of the base body, in which the cogging of the base body is closed on each of both front sides by a flanged wheel and at least one of the flanged wheels is constructed as a separate part.

The above, and other aspects, features and advantages of the present invention, will become apparent from the following description read in conjunction with the accompanying drawings, in which like reference numerals designate the same elements.

### BRIEF DESCRIPTION OF THE DRAWINGS

FIG. 1 shows a perspective view of a first exemplary embodiment of a toothed belt gear with cogging introduced by machining and with pulling cams.

FIG. 2 shows a perspective view of a second exemplary embodiment of a toothed belt gear with cogging introduced by machining.

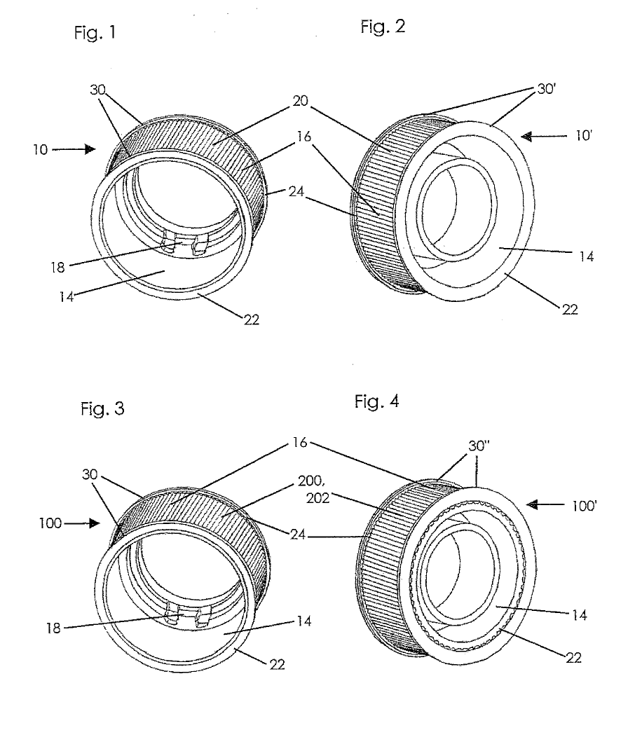

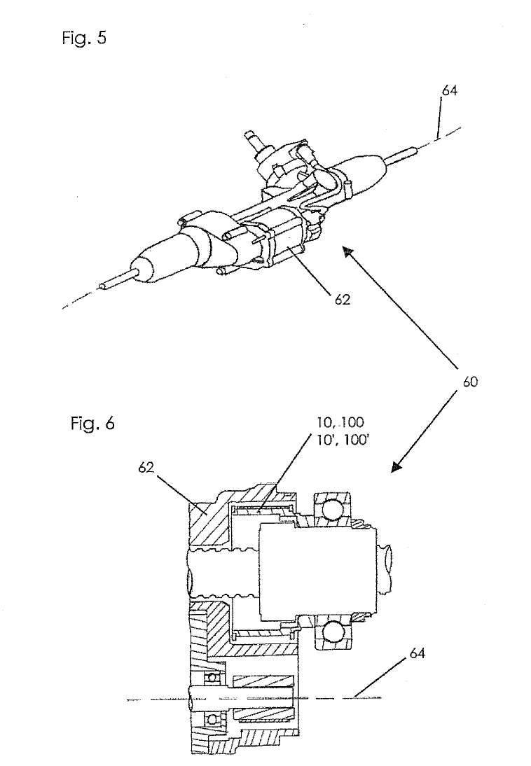

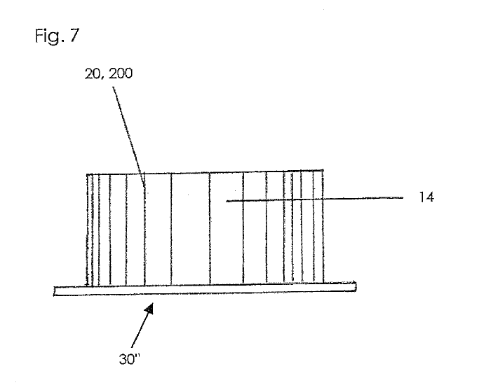

FIG. 3 shows a perspective view of a third exemplary embodiment of a toothed belt gear with injection-molded plastic cogging and with pulling cams.

FIG. 4 shows a perspective view of a fourth exemplary embodiment of a toothed belt gear with injection-molded plastic cogging.

FIG. 5 shows a perspective view of an axially parallel power steering drive in which a toothed belt gear, in accordance with the invention, is used.

FIG. 6 shows an axial section through the toothed belt gear used in the power steering drive shown in FIG. 5 with its surroundings in accordance with its use.

FIG. 7 shows a lateral view of a flanged wheel with base body.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

The four exemplary embodiments of toothed belt gears 10, 10′, 100, 100′ shown in FIGS. 1 to 4 have a cup-shaped or bell-shaped base body 14 of metal as shaping element in common. The same parts are designated with the same reference numerals.

Turning to FIG. 1, there is shown base body 14, a large hole is centrally present. Base body 14 consequently consists substantially only of a hollow cylindrical wall with an inside cross section and an outside cross section.

The inside cross section becomes gradually smaller in the axial direction in the exemplary embodiments shown in FIG. 1 and in FIG. 3. In the exemplary embodiments of FIGS. 2 and 4, the inside cross section is constant in an axial direction. A cogging 20, 200 is placed on an outside circumference 16 of base body 14, or of the wall of base body 14.

Cogging 20, 200 preferably runs axially parallel to base body 14. Basically, even other geometries (not shown) for coggings 20, 200 are conceivable. As a result thereof, only a transfer of force onto an appropriate belt has to be made possible. In the case of the exemplary embodiments shown, it is a toothed belt with cogging vertical to its length. In the case of a belt without cogging, for example, a roughening of the surface of base body 14 would be sufficient.

Cogging 20, 200 of base body 14 is introduced by machining into base body 14 in the first two embodiments (FIG. 1, FIG. 2). Cogging 20, 200 can be advantageously introduced into base body 14 to this end by hobbing. It is especially advantageous, among other things, to select steel sheeting as the metal of base body 14 in order to facilitate the deep drawing, to manufacture a stable toothed belt gear and to make possible the machining introduction of cogging 20.

As an alternative to the machining introduction of a cogging 20, a cogging 200 can be placed on the outside circumference of base body 14 by a contoured plastic layer 202. This corresponds to exemplary embodiments 3 and 4 (FIG. 3, FIG. 4). It is especially advantageous to apply contoured plastic layer 202 onto the outside circumference of base body 14 by injection molding.

Cogging 20, 200 is axially delimited on each of both front sides 22, 24 of base body 14 by a flanged wheel 30, 30′, 30″. The closure of cogging 20, 200 on the front sides 22, 24 base body 14 with flanged wheels 30, 30′, 30″ ensures a secure guidance of a toothed belt. The toothed belt is secured against sliding off by projecting flanged wheels 30, 30′, 30″.

The flanged wheel 30, 30′, 30″ has a greater outside diameter than base body 14 in order to make possible a secure guidance of the belt. Different inside diameters can be considered for flanged wheel 30, 30′, 30″.

The inside diameter of flanged wheel 30 can be approximately equal to the outside circumference of base body 14 if flanged wheel 30 is to be made available, for example, adjacent to cogging 20, 200 on the edge of toothed belt gear 10, 100. Flanged wheel 30 would therefore expand a front side 22, 24 of base body 14 radially outward if it is placed on flushly. This is shown in the first exemplary embodiment (FIG. 1).

The inside diameter of flanged wheel 30′ can also be equal to the inside diameter of base body 14, as is shown in the second exemplary embodiment (FIG. 2). In this instance, cogging 20, 200 can extend over the entire width of base body 14. This would be especially significant if cogging 20, 200 would be raised radially outward over the outside circumference of base body 14, as is explained in the third and fourth exemplary embodiments (FIGS. 3 and 4). An inside diameter of flanged wheel 30 approximately equal to the outside circumference of base body 14 and a placing of flanged wheel 30 adjacent to cogging 20, 200 would namely force a corresponding taking into account and, if necessary, a reworking during the placing of the cogging.

A third possibility for the selection of the inside diameter of flanged wheel 30″ is explained in the fourth exemplary embodiment (FIG. 4) of a toothed belt gear 100′. The inside diameter of flanged wheel 30″ is smaller here than the inside diameter of base body 14.

Flanged wheels 30, 30′, 30″ also have the problem of strengthening base body 14 in addition to guiding the toothed belt. They can be attached to base body 14 either by welding, by pressing them on or by wedging them over. To this end, flanged wheels 30, 30′, 30″ should consist of a suitable material, e.g., of the same material as base body 14. As an alternative to the previously cited variants, it is especially advantageous to injection mold a flanged wheel 30, 30′, 30″ of plastic on a front side 22, 24 of base body 14.

It is within the scope of the invention to apply one or both flanged wheels 30, 30′, 30″ in a manufacturing step together with the contoured plastic layer 202 onto base body 14. The application of the cogging consisting of plastic with a flanged wheel or flanged wheels formed on in one piece at the same time can take place, e.g., by injection molding.

In the case of cogging 20, 200 introduced by machining into the deep-drawn metallic part into toothed belt gear 10, both flanged wheels 30, 30′, 30″ must be designed as separate parts. The process step for the machining makes it necessary that there is a discharge for the miller that mills the cogging past the front sides 22, 24.

The selection of contoured plastic layer 202 as applied cogging 200 makes an embodiment of flanged wheel 30, 30′, 30″ possible in which the flanged wheel 30, 30′, 30″ is clipped into contoured plastic layer 202. Another fastening of flanged wheel 30, 30′, 30″ is given, e.g., by a positive closure of flanged wheel 30, 30′, 30″ with contoured plastic layer 202. Connections between plastic parts 30, 30′, 30″ can alternatively also be performed by welding with ultrasound or laser.

Toothed belt gear 10, 100 should transmit a force from an output shaft of a drive onto a toothed belt. Toothed belt gear 10, 100 must consequently be able to be driven directly or indirectly by the output shaft. To this end, e.g., base body 14 is provided with pulling cams 18 projecting radially inward in the hole of the base body. Such a pulling cam 18 can be seen in FIGS. 1 and 3. Pulling cams 18 can engage in corresponding contours of the output shaft of the drive.

For the case that the output shaft or another element in an operative connection with toothed belt gear 10, 10′, 100, 100 comprises positive elevations, formed, e.g., as cams, instead of negative formations for receiving pulling cams 18, recesses for receiving such elevations (not shown) are provided in base body 14 as an alternative.

Non-positive connections between toothed belt gear 10, 100 and the output shaft can also alternatively be constructed by press fitting or other connections (e.g., a fixing of a flanged wheel with such connections on the driving element is especially advantageous.

Another exemplary embodiment of a flanged wheel 30″ shown in FIG. 7 goes beyond the exemplary embodiments of FIGS. 1 to 4 in as far as flanged wheel 30′″ makes available a cup-shaped or bell-shaped base body 14 with cogging 20, 200. Two such flanged discs 30′″ form a toothed belt gear in common in coaxial arrangement if their base bodies facing each other are connected to each other so that flanged wheels 30′″ are arranged facing away from each other.

A process for the manufacture of a toothed belt gear 10, 10′ such as is indicated, e.g., in exemplary embodiments 1 and 2 comprises as the first step the deep drawing of the cup-shaped or bell-shaped base body 14 from a metal. A second step is the machining introduction of cogging 20 into base body 14 on its outer circumference 16. In a third step, two flanged wheels 30, 30′, 30″ are made available on the front sides 20, 24 of base body 14. Finally, at least one of flanged wheels 30, 30′, 30″ is fastened on a front side 22, 24 of base body 14.

A process for the manufacture of a toothed belt gear 100, 100′ such as is indicated, for example, with exemplary embodiments 3 and 4 also comprises as the first process step the deep drawing of the cup-shaped or bell-shaped base body 14 from a metal. In a second process step, the cogging 200 of plastic is applied onto the base body on its outside circumference 16. In a third process step, at least one flanged wheel 30, 30′, 30″ is made available on front sides 22, 24 of base body 14, after which at least one flanged wheel 30, 30′, 30″ is fastened in a fixed manner, in a fourth process step, on one of the front sides of base body 14.

Toothed belt gears 10, 10′, 100, 100″ and the last-described toothed belt gear consisting of two flanged wheels 30′″ are preferably used in power steering drives. Such a power steering drive 60 is shown in FIGS. 5 and 6. It becomes clear in illustration 5 that power steering drive 60 is constructed in an axially parallel manner. A drive housing 62 of power steering drive 60 is arranged here parallel to a power steering shaft 64. Drive housing 62 contains the toothed belt gear that brings about a non-positive transmission onto the coaxial power steering shaft 64 via the toothed belt.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A toothed belt gear for a toothed belt drive, said toothed belt gear comprising:
(a) a cup-shaped or bell-shaped base body of metal; and
(b) a cogging arranged on the outside circumference of said base body, and, characterized in that
(i) said cogging of said base body is closed on each of both front sides by a flanged wheel, and
(ii) at least one of said flanged wheels is constructed as a separate part.

2. The toothed belt gear according to claim 1, characterized in that said cogging is applied by a contoured plastic layer onto the outside circumference of said base body.

3. The toothed belt gear according to claim 2, characterized in that said contoured plastic layer is injection-molded onto the outside circumference of said base body.

4. The toothed belt gear according to claim 1, characterized in that said at least one flanged wheel is applied on said base body by welding.

5. The toothed belt gear according to claim 1, characterized in that said at least one flanged wheel is applied on said base body by pressing.

6. The toothed belt gear according to claim 1, characterized in that said at least one flanged wheel is applied on said base body by wedging.

7. The toothed belt gear according to claim 1, characterized in that a flanged wheel of plastic is injection-molded on a front side of said base body.

8. The toothed belt gear according to claim 2, characterized in that a flanged wheel is clipped into said contoured plastic layer.

9. The toothed belt gear according to claim 2, characterized in that a flanged wheel is positively connected to said contoured plastic layer.

10. The toothed belt gear according to claim 1, characterized in that said cogging is introduced by machining into said base body.

11. The toothed belt gear according to claim 1, characterized in that said cogging is introduced into said base body by hobbing.

12. The toothed belt gear according to claim 1, wherein the metal of said base body is steel sheeting.

13. The toothed belt gear according to claim 1, characterized in that said base body is provided with a set of pushing cams and that said set of pushing cams project radially inward from said base body.

14. The toothed belt gear according to claim 1, characterized in that said base body comprises at least one recess for receiving a corresponding cam of a shaft or of a hub.

15. The toothed belt gear according to claim 2, characterized in that said contoured plastic layer and a flanged wheel are constructed in one piece.

16. The toothed belt gear according to claim 2, characterized in that at least one connection is created between plastic parts by welding with ultrasound.

17. The toothed belt gear according to claim 2, characterized in that at least one connection is created between plastic parts by welding with a laser.

18. The toothed belt gear according to claim 1, wherein a use of said toothed belt gear is in a power steering drive.

19. The toothed belt gear according to claim 1, wherein said power steering drive is constructed in an axially parallel manner.

20. A process for manufacturing a toothed belt gear, comprising the steps of:
(a) deep-drawing of a cup-shaped or bell-shaped base body from a sheeting;
(b) machining introduction of a cogging into said base body on the outer circumference of said base body;
(c) making available two flanged wheels on the front sides of said base body; and
(d) fastening of at least one of said flanged wheels on a front side of said base body.

21. The process for manufacturing a toothed belt gear, said process comprising the steps of:
(a) deep-drawing of a cup-shaped or bell-shaped base body from a sheeting;
(b) applying a plastic cogging onto said base body on said base body's outer circumference;
(c) making available two flanged wheels on the front sides of said base body; and
(d) fastening of at least one of said flanged wheels on a front side of said base body.
